(19) United States
(12) Patent Application Publication
(10) Pub. No.: US 2009/0084947 A1
(43) Pub. Date: Apr. 2, 2009

(54) METHOD FOR CALIBRATING NUCLEAR MEDICINE DIAGNOSIS APPARATUS

(76) Inventors: Norihito YANAGITA, Hitachi (JP); Shinichi Inoue, Ryugasaki (JP); Katsutoshi Tsuchiya, Hitachi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/039,413

(22) Filed: Feb. 28, 2008

(30) Foreign Application Priority Data
Sep. 28, 2007 (JP) 2007-252958

(51) Int. Cl. G12B 13/00

(52) U.S. Cl. 250/252.1

(57) ABSTRACT

A nuclear medicine diagnosis apparatus, which rotates a rod-shaped radiation source or a point radiation source while changing the radius thereof and carries out a calibration work, is provided to resolve the following problems. If detector calibration is carried out using a cylindrical phantom whose interior is filled with a ¹⁸F solution, for example, there is a risk that a γ-ray is scattered by the aqueous solution itself inside the cylindrical phantom. Although there is a method for correcting the scattered radiation, the method has a disadvantage that the correction results in poor calibration. Moreover, if a rod-shaped radiation source is rotated inside a tunnel, there is an extremely low risk of causing the above-described scattering because it is rod-shaped. However, this rod-shaped radiation source only rotates on an orbit of a certain radius, resulting in a ring-shaped radiation source having a hollow portion thereinside.

### BACKGROUND OF THE INVENTION

The present invention relates to a method for calibrating radiation detection apparatus using radiation.

With an inspection technique using radiation, the interior of a subject can be inspected in a non-destructive manner. In particular, radiographic inspection techniques for a human body include an X-ray CT, a PET, a single photon emission type CT (hereinafter, referred to as “SPECT”: Single Photon Emission Computed Tomography), and the like. In operating the radiographic inspection apparatus, calibrating the apparatus in advance is an essential process in securing the image quality performance of the apparatus. If the calibration has not been carried out sufficiently, a tomographic image may degrade significantly.

As a technique for performing calibration, JP-A-2002-71813 describes a PET including a calibration radiation source P, wherein a rod-shaped radiation source is disposed in a rotating ceptor and revolves in the cylindrical space of a gantry.

### SUMMARY OF THE INVENTION

The calibration of detection efficiency is roughly divided into two types: calibration of sensitivity variations of a large number of detectors included in an apparatus (detector efficiency calibration); and calibration of sensitivity variations caused by positional variations and the like of the detectors (geometrical efficiency calibration).

The former detector efficiency calibration is carried out using a cylindrical phantom whose interior is filled with a ¹⁸F solution, for example. Here, the cylindrical phantom is just disposed inside a gantry tunnel to collect γ-ray detection information, so the measurement is easy. On the other hand, there is a risk that a γ-ray is scattered by an aqueous solution itself inside the cylindrical phantom. Although there is a method for correcting the scattered radiation, the method has a disadvantage that the correction results in poor calibration.

The latter geometrical efficiency calibration is carried out by rotating, for example, a ⁶⁸Ge—⁶⁸Ga rod-shaped radiation source inside a tunnel. This has an extremely low risk of causing the above-described scattering because it is rod-shaped. However, this rod-shaped radiation source only rotates on an orbit of a certain radius and thus results in a ring-shaped radiation source having a hollow portion thereinside.

Accordingly, the calibration work will not complete unless two radiation sources are prepared, and this is a very time consuming work. As the calibration method, the one complementing both drawbacks described above is desirable. The ideal one as this method is to achieve a “cylindrical phantom that will not scatter γ-rays thereinside” in an emulating manner.

A means to solve the above-described problems is to rotate a rod-shaped radiation source or a point radiation source while changing the radius thereof and perform calibration work.

According to the present invention, the following effect can be obtained.

A cylindrical phantom without scattered radiation is achieved in an emulating manner, so that the accuracy on detection efficiency calibration will increase and the quality of a tomographic image will improve.

Other objects, features and advantages of the invention will become apparent from the following description of the embodiments of the invention taken in conjunction with the accompanying drawings.

### BRIEF DESCRIPTION OF THE DRAWINGS

FIG. 1 is a view showing a configuration of a PET apparatus that is an example of a nuclear medicine diagnosis apparatus.

FIG. 2A illustrates a cross section along the center axis direction of a tunnel of a camera 11, and a rotation mechanism that attaches or detaches a rod-shaped radiation source to a plurality of different radial positions and rotates the radiation source.

FIG. 2B illustrates a set of radiation source rotation orbits seen from the front side (back side) of a gantry.

FIG. 3A illustrates a cross section along the center axis direction of a tunnel of the camera 11, and a rotation mechanism that variably disposes a rod-shaped radiation source at different radial positions and rotates the radiation source.

FIG. 3B illustrates a set of radiation source rotation orbits seen from the front side (back side) of a gantry.

FIG. 4A illustrates a cross section along the center axis direction of a tunnel of the camera 11, and a rotation mechanism of a rod-shaped radiation source for attaching or detaching a radiation source to a plurality of different radial positions.

FIG. 4B illustrates a set of radiation source rotation orbits seen from the front side (back side) of a gantry.

FIG. 5A illustrates a cross section along the center axis direction of a tunnel of the camera 11, and a rotation mechanism of a rod-shaped radiation source for variably disposing the radiation source at different radial positions.

FIG. 5B illustrates a set of radiation source rotation orbits seen from the front side (back side) of a gantry.

FIG. 6A illustrates a rotating shaft-directional sliding device provided in a rotation device.

FIG. 6B illustrates a set of radiation source rotation orbits seen from the front side (back side) of a gantry.

### DESCRIPTION OF THE EMBODIMENTS

Next, a nuclear medicine diagnosis apparatus of an embodiment of the present invention will be described in detail suitably referring to the accompanying drawings.

### Embodiment 1

Any inspection technique using radiation is a technique, in which the physical quantity of a subject to be inspected is measured as an integrated value in the radiation traveling direction, and its integrated value is back projected to calculate the physical quantity of each voxel inside the subject and create an image. In this technique, a large amount of data needs to be processed, and along with the rapid development of computer technologies in recent years, high speed and highly detailed images have come to be provided.

The X-ray CT technique is a technique, in which the intensity of an X-ray passing through a subject is measured, and from the X-ray transmission coefficient inside the body the morphological information on the subject is imaged. X-rays are emitted from an X-ray source to a subject, whereby the intensity of an X-ray passing through the body is measured with detecting elements disposed opposite to the subject, thereby measuring a distribution of integrated absorption coefficients of the subject. From these integrated absorption coefficients, an absorption coefficient of each voxel is calculated using a filtered back projection method or the like and this value is converted to a CT value. The energy of a radiation source often used in the X-ray CT is approximately around 80 keV.

On the other hand, PET and SPECT are approaches capable of detecting a function or metabolism at a molecular biological level which the X-ray CT and the like cannot detect, and capable of providing functional images of a human body. PET is an approach of injecting a radiopharmaceutical labeled by a positron emission nuclide, such as ¹⁸F, ¹⁵O, or ¹¹C, and measuring the distribution thereof to create an image. The above-described medicines include fluorodeoxy glucose (2-[F-18] fluoro-2-deoxy-D-glucose, ¹⁸FDG) or the like, which is used to identify a tumor site by utilizing the fact that the medicine will accumulate in a tumor organ due to sugar metabolism.

The radiation nuclide introduced into a body will decay to emit a positron (β+). The emitted positron will emit a pair of annihilation γ-rays (annihilation γ-ray pair) having an energy of 511 keV, respectively, when the positron combines with an electron and the two annihilate. Since the annihilation γ-ray pair are emitted in directions almost opposite to each other (180±0.6 degrees), the annihilation γ-ray pair can be simultaneously detected with detecting elements that are disposed so as to surround the circumference of the subject, and a projection data can be obtained by accumulating this radiated direction data. By back projecting the projection data (using the above-described filtered back projection method or the like), the radiation position (accumulation position of the radiation nuclide) can be identified and imaged.

SPECT is an approach of injecting a radiopharmaceutical labeled with a single photon emission nuclide and measuring the distribution thereof to create an image. A single γ-ray having an energy of approximately 100 keV is emitted from the medicine, and this single γ-ray is measured with a detecting element. In the single γ-ray measurement, the traveling direction cannot be identified. Accordingly, in the SPECT, a collimator is inserted in the front side of a detecting element and a projection data is obtained by detecting only a γ-ray traveling from a specific direction. As in the PET, the projection data is back projected using the filtered back projection method or the like to obtain an image data. What differs from the PET is, for example, that the coincidence measurement is not necessary due to the single γ-ray measurement and thus fewer detecting elements are required. Accordingly, the configuration of the apparatus is simple and the apparatus is relatively inexpensive.

Note that, in this embodiment, as an imaging apparatus constituting the nuclear medicine diagnosis apparatus, an PET apparatus is described as an example.

In this embodiment, the calibration work is carried out by rotating a rod-shaped radiation source or a point radiation source while changing the radius thereof. By rotating the radiation source while changing the radius thereof, a set of multiple ring-shaped radiation sources with different radiuses, accordingly a “cylinder”, can be emulated. Nevertheless, the rod-shaped radiation source and point radiation source would produce extremely few internal scatterings. As a result, the above-described “cylindrical phantom that will not scatter γ-rays thereinside” can be achieved.

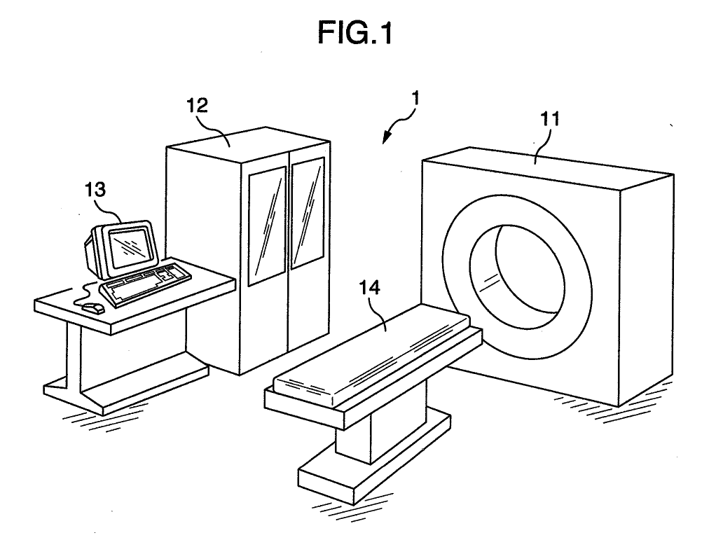

FIG. 1 illustrates a whole configuration of the PET apparatus. A PET apparatus 1 mainly comprises an imaging apparatus 11 (here, referred to as a camera), a bed 14, a data processor 12, and a display device 13. Among them, at least the display device 13 is disposed outside an inspection room. A human subject is placed on the bed 14 and photographed with the camera 11. The data processor 12 receives the data photographed with the camera 11, and processes these data to prepare an image data. The display device 13 displays the image data prepared by the data processor 12.

The data processor 12 carries out coincidence measurement processing and tomogram information preparation processing. The data processor 12 captures a packet data containing a peak value of a detected γ-ray, a detection time data, and a detector (channel) ID. In the coincidence measurement processing, coincidence measurement is carried out based on this packet data, in particular the detection time data and detector ID, to identify the detection position of a 511 KeV γ-ray and stores this in a storage device. In the tomogram information preparation processing, based on this identified position a functional image is prepared and displayed on the display device 13.

Now, specific configurations and calibration methods of this embodiment will be described with Method 1 to Method 4 below.

### (Method 1)

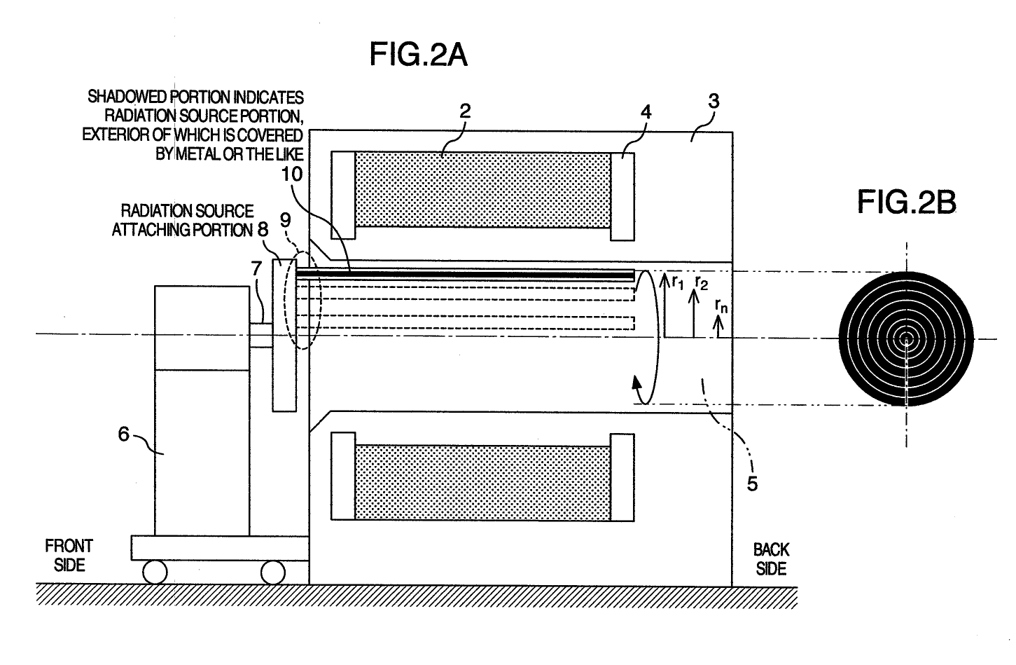

A rotation device is disposed in the front side of a gantry. In the rotation device, a rod-shaped radiation source can be attached or detached at a plurality of different radial positions r₁, . . . rₙ. Hereinafter, description is made using FIGS. 2A, 2B.

FIG. 2A illustrates a cross section in the direction of a tunnel center axis of the camera 11, and a rotation mechanism that attaches or detaches a rod-shaped radiation source to a plurality of different radial positions and rotates the radiation sources. The camera 11 comprises a detector 2 for detecting radiation, a gantry 3, and an end shield 4. The camera 11 incorporates a large number of detectors 2 (see FIG. 2A), wherein a γ-ray emitted from the body of a human subject is detected with the detector 2. The camera 11 includes a non-illustrated circuit board, in which an integrated circuit (ASIC) for measuring a peak value and detection time of a γ-ray obtained from the detector 2 is mounted so that the peak value and detection time of a detected radiation (γ-ray) may be measured. The gantry 3 holds the detector 2. Moreover, in the gantry 3, a tunnel 5 through which a subject is inserted is formed. Although the tunnel 5 is shown here, an open type imaging apparatus may be employed, in which the detector 2 is disposed only in the upper part and the lower part so that a side wall of the gantry may be opened. The end shield 4 shields radiation coming from the outside of the gantry 3 and causing noise.

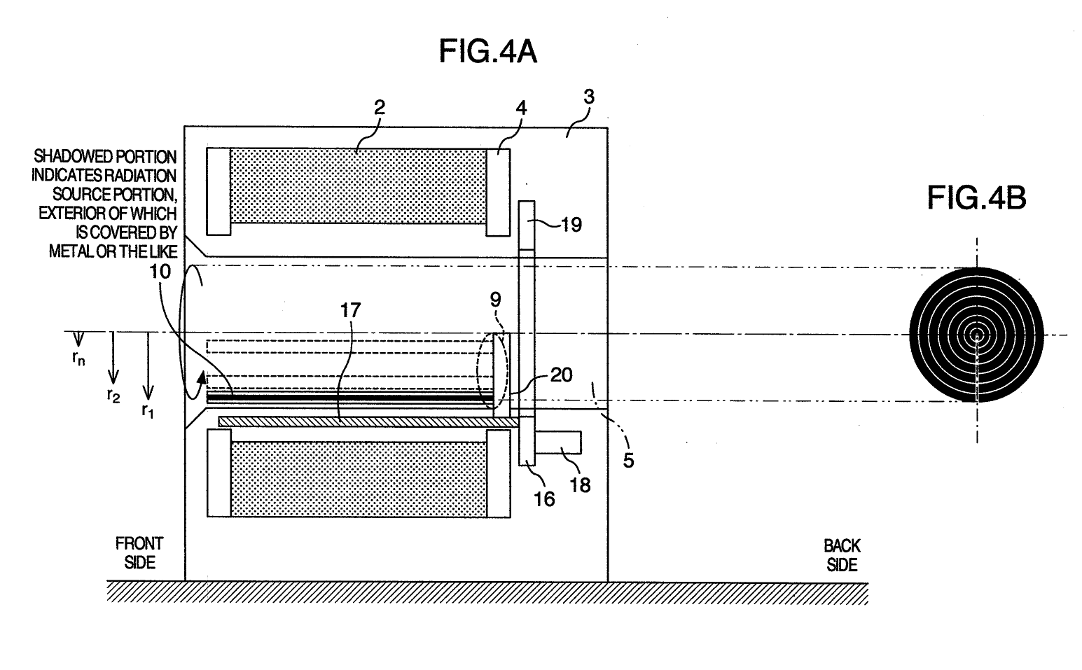

The rotation device 6 is a device for rotating the rod-shaped radiation source 10, which is the calibration radiation source. The rotation device 6 rotates a rotating part 8, which is a radiation source mounting part to which the rod-shaped radiation source 10 is attached, about a rotating shaft 7. The rotation device 6 may be provided inside the gantry 3 as in an absorption-correcting rotation device 16 of FIG. 4 described later. A radiation source attaching or detaching part 9 is a portion of the rotating part 8, the portion facing the gantry side shown by a dotted line, where a rod-shaped radiation source can be attached or detached at a plurality of different radial positions r₁, . . . rₙ, in the radial direction from the center axis 7. In the rod-shaped radiation source 10, a radiation source body part, which is a main part of the radiation source, is covered by an external film of metal or the like.

If the calibration radiation sources are rotated by the rotation device 6, then, as shown in FIG. 2B, a set of rotation orbits of the radiation sources is obtained at a plurality of different radial positions r₁, . . . rₙ of concentric circles. A rotation mechanism is disposed in the front side or the back side of the gantry, whereby a radiation source is attached or detached to a plurality of different radial positions of the rotation mechanism to calibrate the nuclear medicine diagnosis apparatus. Thereby, a cylindrical phantom without scattered radiation can be achieved in an emulating manner, so that the accuracy on detection efficiency calibration will increase and the quality of a tomographic image will improve.

### (Method 2)

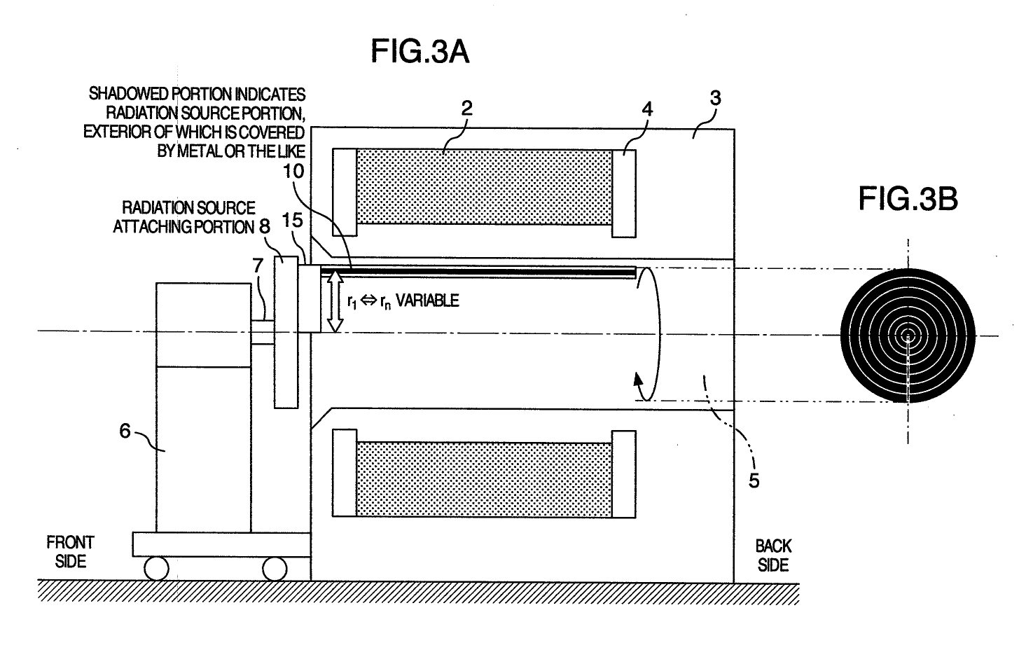

The rotation device is disposed in the front side of the gantry. The rotation device has a function to automatically change the turning radius, so that a rod-shaped radiation source may be rotated at a plurality of turning radiuses across r₁, . . . rₙ. Thereby, γ-ray measurement is carried out at a plurality of radius positions. Hereinafter, description is made using FIGS. 3A, 3B. The description of the same configuration as that of FIG. 2A is omitted. A radius automatic-variable slider 15 is provided in place of the radiation source attaching or detaching part 9 of FIG. 2A. The radius automatic-variable slider 15 can slidably move a rod-shaped radiation source to a plurality of different radial positions, from the center axis 7 to the radial direction. Moreover, the radius automatic-variable slider 15 is mechanically or electrically driven to automatically move a rod-shaped radiation source, for example, to a predetermined position or at a predetermined speed.

The rotation device is disposed in the front side or the back side of the gantry, and the rotation device automatically changes the turning radius of a radiation source, and rotates the calibration radiation source to calibrate the apparatus. Thereby, a cylindrical phantom without scattered radiation can be achieved in an emulating manner, so that the accuracy on detection efficiency calibration will increase and the quality of a tomographic image will improve.

### (Method 3)

A radius variable device is attached to an absorption-correcting rotation mechanism incorporated in the PET apparatus. This radius variable device can attach or detach a rod-shaped radiation source to a plurality of radius positions r₁, . . . rₙ. This radius variable device carries out a γ-ray measurement at a plurality of radius positions r₁, . . . rₙ. Hereinafter, description is made using FIGS. 4A, 4B. The description of the same configuration as that of FIG. 2A is omitted. An absorption-correcting rotation device 16 is provided in place of the rotation device 6 of FIG. 2A. The absorption-correcting rotation device 16 includes an absorption-correcting radiation source holder 17, a motor 18, and a gear 19. The absorption-correcting radiation source holder 17 holds a radius variable device 20 and the rod-shaped radiation source 10, and comprises a radiation absorber for absorption correction. The motor 18 rotates the absorption-correcting radiation source holder 17 via the gear 19. The radius variable device 20 attaches or detaches a radiation source to a plurality of different radial positions as in the radiation source attaching or detaching part 9 of FIG. 2A. The structure gear 19 can shift gears in accordance with the position of the rod-shaped radiation source 10.

The radius variable device is attached to the absorption-correcting rotation device incorporated in the nuclear medicine diagnosis apparatus, whereby the radiation source is attached or detached to a plurality of different radial positions of the radius variable device to calibrate the device. Thereby, a cylindrical phantom without scattered radiation can be achieved in an emulating manner, so that the accuracy on detection efficiency calibration will increase and the quality of a tomographic image will improve.

### (Method 4)

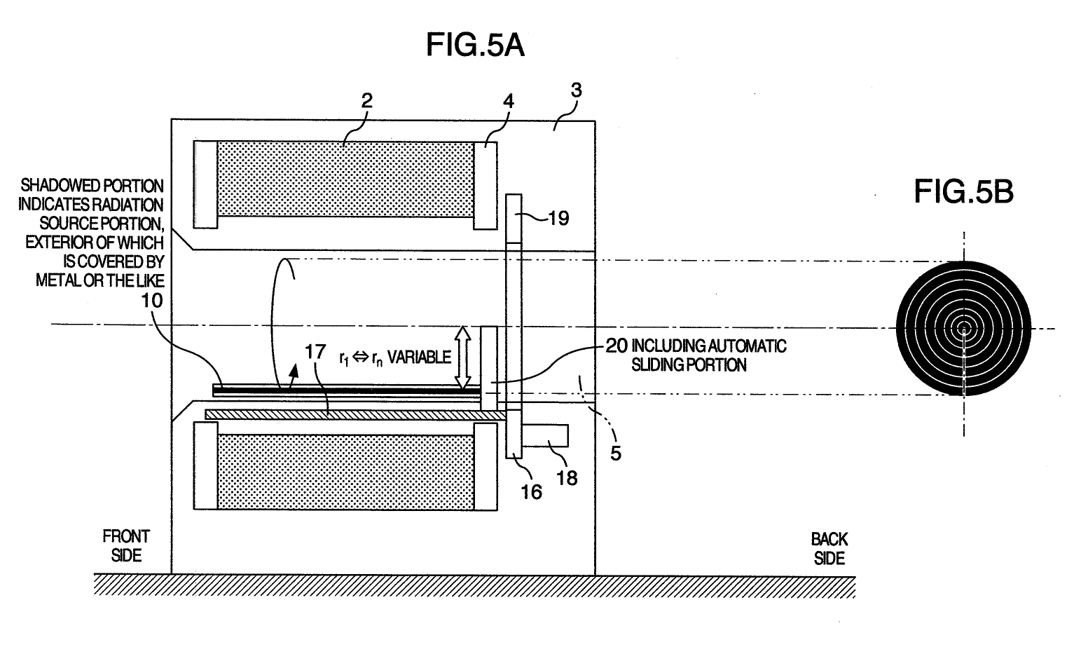

The radius variable device is attached to the absorption-correcting rotation mechanism incorporated in the PET apparatus. This radius variable device has a function to automatically change the radius, so that a rod-shaped radiation source can be rotated at a plurality of turning radiuses across r₁, . . . rₙ. Thereby, γ-ray measurement is carried out at a plurality of radius positions. Hereinafter, description is made using FIGS. 5A, 5B. The description of the same configuration as the above-described one is omitted. The radius variable device 20 can slidably move a rod-shaped radiation source to a plurality of different radial positions, from the center axis to the radial direction, as in the radius automatic-variable slider 15 of FIG. 3A.

The radius variable device is attached to the absorption-correcting rotation device incorporated in the nuclear medicine diagnosis apparatus, whereby the turning radius of a radiation source of the radius variable device is automatically changed to calibrate the apparatus. Thereby, a cylindrical phantom without scattered radiation can be achieved in an emulating manner.

With Methods 1 to 4 described above, a radiation from a calibration radiation source is detected, and based on the detected data each detector is calibrated. In this calibration, in order to correct variations in the sensitivities of a plurality of detectors, a calibration radiation source is rotated to detect radiation, and based on this detected information a sensitivity correction factor for each detector is calculated and stored in a memory in advance, whereby the sensitivity correction for a data after measurement is carried out using this sensitivity correction factor. The memory for storing this sensitivity correction factor may be provided in a circuit board including an amplifier for amplifying a signal from a detector, or may be provided in the data processor 12.

In the method for calibrating a nuclear medicine diagnosis apparatus of this embodiment, while rotating a radiation source at a plurality of different turning-radius orbits in the space of a gantry, the radiation detection data is collected to calibrate the apparatus. This has the following advantages.

(1) A cylindrical phantom without scattered radiation is achieved in an emulating manner, so that the accuracy on detection efficiency calibration is increased and the quality of a tomographic image is improved.

(2) The detector efficiency calibration and the geometrical efficiency calibration can be carried out at the same time. That is, the time and effort (=operating cost) of the calibration work are reduced significantly.

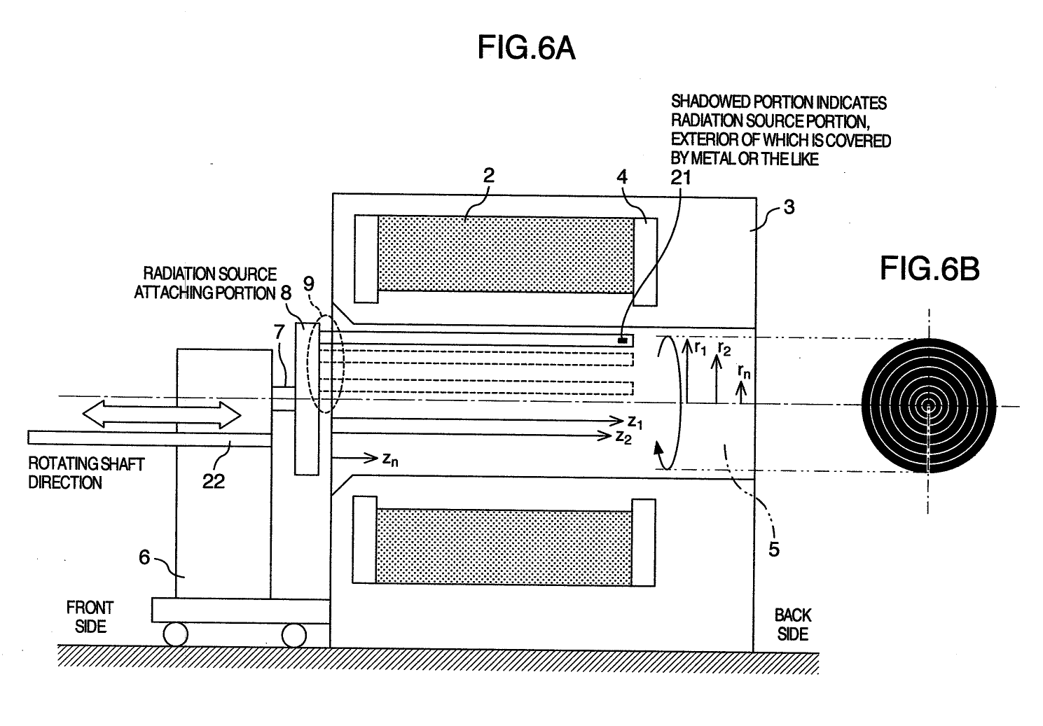

A calibration method using a point radiation source is described using FIGS. 6A, 6B. FIGS. 2A, 2B to FIGS. 5A, 5B show the cases where a rod-shaped radiation source is used, while in the case where a point radiation source is used, a portion movable in the body axis direction may be added to FIGS. 2A, 2B to FIGS. 5A, 5B. For example, in the case of Method 1 of FIG. 2A, a body-axis directional sliding mechanism may be provided in the rotation mechanism, whereby the point radiation source may be rotated sequentially while shifting the point radiation source to body-axis positions z₁, . . . zₙ. Hereinafter, description is made using FIG. 6A. The description of the same configuration as the above-described one is omitted. The rotation device 6 of FIG. 6A includes a rotating shaft-directional sliding device 22 and a point radiation source 21. The point radiation source 21 is used as the calibration radiation source in place of the rod-shaped radiation source 10 of FIG. 2A. The rotating shaft-directional sliding device 22 moves the point radiation source 21 to the axis direction of the rotating shaft 7. The rotating shaft-directional sliding device 22 moves the point radiation source 21 by a mechanical or electrical drive. Movement in the shaft direction of the rotating shaft-directional sliding device 22 can be automatically carried out based on the contents of movement, such as a predetermined position or a predetermined speed.

The radius variable device is attached to the absorption-correcting rotation device incorporated in the nuclear medicine diagnosis apparatus, whereby a radiation source is attached or detached to a plurality of different radial positions of the radius variable device to calibrate the apparatus. Thereby, a cylindrical phantom without scattered radiation can be achieved in an emulating manner, so that the accuracy on detection efficiency calibration will increase and the quality of a tomographic image will improve.

### Embodiment 2

The rod-shaped radiation source and point radiation source described in Embodiment 1 may be in the form of liquid like a ¹⁸F solution instead of in the form of solid. In a rod-shaped radiation source in the form of solid, such as a conventional ⁶⁸Ge—⁶⁸Ga, for convenience of the manufacture, radioactivity is likely to fluctuate (e.g., approximately ±10%) in the length direction of the rod, possibly resulting in poor calibration. The use of a liquid radiation source makes the radioactivity spatially uniform and secures more accurate calibration.

In the calibration method of a nuclear medicine diagnosis apparatus of this embodiment, a liquid radiation source is used as the radiation source, and while rotating the liquid radiation source at a plurality of different turning-radius orbits inside the tunnel of a gantry that collects radiation detection data, the radiation detection data is collected to calibrate the apparatus. Accordingly, other than the advantages of (1) and (2) of Embodiment 1, Embodiment 2 has the following advantage.

(3) The use of an aqueous solution-like radiation source makes radioactivity spatially uniform (mainly, in the body axis direction). That is, the accuracy on the detection efficiency calibration will increase and the quality of a tomographic image will improve.

It should be further understood by those skilled in the art that although the foregoing description has been made on embodiments of the invention, the invention is not limited thereto and various changes and modifications may be made without departing from the spirit of the invention and the scope of the appended claims.

1. A method for calibrating a nuclear medicine diagnosis apparatus, the method comprising the steps of:
collecting a radiation detection data while rotating a radiation source at a plurality of different turning-radius orbits in a space of a gantry; and
calibrating the apparatus.

2. The method for calibrating a nuclear medicine diagnosis apparatus according to claim 1, further comprising the step of:
disposing a rotation device in a front side or back side of the gantry; and
attaching or detaching a radiation source to a plurality of different radial positions of the rotation device.

3. The method for calibrating a nuclear medicine diagnosis apparatus according to claim 1, further comprising a step of disposing a rotation device in a front side or back side of the gantry, wherein the rotation device automatically changes a turning radius of the radiation source.

4. The method for calibrating a nuclear medicine diagnosis apparatus according to claim 1, further comprising the steps of:
attaching a radius variable device to an absorption-correcting rotation device incorporated in the nuclear medicine diagnosis apparatus; and
attaching or detaching the radiation source to a plurality of different radial positions of the radius variable device.

5. The method for calibrating a nuclear medicine diagnosis apparatus according to claim 1, further comprising the steps of:
attaching a radius variable device to an absorption-correcting rotation device incorporated in the nuclear medicine diagnosis apparatus; and
automatically changing a turning radius of the radiation source of the radius variable device.

6. The method for calibrating a nuclear medicine diagnosis apparatus according to claim 1, wherein the radiation source is a point radiation source, and wherein the rotation mechanism includes a rotating shaft-directional variable slide mechanism, the method further comprising the steps of:
rotating the point radiation source while shifting a body-axis position; and
collecting a radiation detection data.

7. The method for calibrating a nuclear medicine diagnosis apparatus according to claim 1, further comprising a step of collecting a radiation detection data using a liquid radiation source as the radiation source.
